(19) United States
(12) Patent Application Publication
(10) Pub. No.: US 2025/0141799 A1
(43) Pub. Date: May 1, 2025

(54) DEEP-PACKET INSPECTION OF MULTICAST FLOWS

(71) Applicant: Hewlett Packard Enterprise Development LP, Spring, TX (US)

(72) Inventors: Venkatavaradhan Devarajan, Bangalore (IN); Tathagata Nandy, Bangalore (IN)

(21) Appl. No.: 18/495,474

(22) Filed: Oct. 26, 2023

(51) Int. Cl. H04L 45/745; H04L 9/40; H04L 45/24

(52) U.S. Cl. CPC H04L 45/745; H04L 45/245; H04L 63/104

(57) ABSTRACT

An access switch, which can connect one or more end devices to a network, is provided. During operation, the access switch can identify a multicast flow associated with a multicast group based on one or more packets received at the access switch. The access switch can store a flow identifier of the multicast flow in an entry of a data structure stored in a storage device of the access switch. Subsequently, the access switch can facilitate deep-packet inspection on the multicast flow. To do so, the access switch can determine a set of properties associated with the multicast flow based on a plurality of packets of the multicast group and determine a multicast traffic class for the multicast flow based on the set of properties. The access switch can then store a label identifying the multicast traffic class in the entry of the data structure.

### BACKGROUND

A network device, such as a switch, in a network may support different protocols and services. For example, the network device can support one or more multicast protocols to facilitate the distribution of certain classes of traffic, such as video streaming and online gaming.

### BRIEF DESCRIPTION OF THE FIGURES

FIG. 1 illustrates an example of a network supporting deep-packet inspection of multicast flows, in accordance with an aspect of the present application.

FIG. 2 illustrates an example of a multicast deep-packet inspection (MDPI) system gleaning information from a multicast flow, in accordance with an aspect of the present application.

FIG. 3A illustrates an example of a class data structure based on which an MDPI system classifies a multicast flow, in accordance with an aspect of the present application.

FIG. 3B illustrates an example of an overlay class data structure based on which an MDPI system classifies a multicast flow in an overlay network, in accordance with an aspect of the present application.

FIG. 4 presents a flowchart illustrating an example of a process of a switch performing a deep-packet inspection on a multicast flow in a network, in accordance with an aspect of the present application.

FIG. 5A presents a flowchart illustrating an example of a process of a switch classifying a multicast flow in a network, in accordance with an aspect of the present application.

FIG. 5B presents a flowchart illustrating an example of a process of a switch selecting multicast packets to perform a deep-packet inspection, in accordance with an aspect of the present application.

FIG. 6 illustrates an example of a switch supporting deep-packet inspection of multicast flows, in accordance with an aspect of the present application. In the figures, like reference numerals refer to the same figure elements.

### DETAILED DESCRIPTION

In various Internet applications, multicast is frequently used to distribute content such as video from a source to multiple hosts via one or more network devices, such as switches. Efficient distribution of multicast traffic can improve the performance of a network. A network-layer multicast protocol, such as protocol-independent multicast (PIM), can be used for distributing content in a heterogeneous network. In some scenarios, a host can send a client join request (e.g., an Internet Group Management Protocol (IGMP) join request or a Multicast Listener Discovery (MLD) join request) to an upstream switch. The switch can be in an overlay network, such as a tunnel fabric, formed based on overlay routing for a VPN over a set of tunnels. For example, an Ethernet VPN (EVPN) can be deployed as an overlay over a set of virtual extensible local area networks (VXLANs).

To allocate bandwidth and resources for multicast traffic in the network, recognizing different types of multicast traffic flows (or multicast flows) in the network can be useful. For example, if a network administrator can identify which switches in a network are forwarding Internet Protocol (IP) television (IPTV) streaming, the administrator can allocate resources for the switches accordingly. Typically, a switch can perform a deep-packet inspection (DPI) to glean information about the data flows forwarded by the switch. To do so, the DPI process can inspect beyond the standard header processing performed to forward a packet. Accordingly, the DPI process method can analyze the traffic pattern and the payload (i.e., beyond data link, IP, and transport headers) to identify the type of traffic and the application associated with the traffic. However, because multicast traffic forwarding can be one-to-many and often unsolicited (e.g., to a Rendezvous Point (RP)), traditional DPI process may not identify respective traffic classes and corresponding applications of different multicast flows in a network.

The aspects described herein address the problem of efficiently performing a DPI on multicast flows in a network by (i) capturing a set of relevant packets from a multicast flow and analyzing the packets to determine a set of properties; (ii) comparing the set of properties to respective parameters of multicast traffic patterns; and (iii) classifying the multicast flow to a corresponding traffic class based on the comparison. By matching the set of properties to a traffic pattern, the traffic class and the corresponding application can be determined.

With existing technologies, performing a DPI on a packet involves processing beyond the header of the packet. A typical DPI process can rely on examining bi-directional flows associated with request and response packets. Because multicast packets are not associated with a particular source-destination pair, the request and response paradigm can be absent for a multicast flow. Therefore, performing DPI on a multicast packet can be challenging. Extracting information from multicast packets can be even more challenging if the multicast packets are sent via overlay tunnels. Furthermore, information associated with some multicast data flows, such as port information, may not be universally defined. As a result, performing traditional DPI on multicast packets may not determine the type of data flow of the multicast packets. Without performing DPI on multicast flows, telemetry associated with the multicast flows may not be collected. Consequently, an administrator may not be able to allocate resources accordingly.

To address this problem, a multicast DPI (MDPI) system capable of performing DPI on multicast flows can be deployed on the access switches. An access switch can be an edge switch in a network that can connect one or more end devices to the network. The MDPI system can maintain a set of traffic classes (e.g., video streaming, surveillance, signaling, etc.) associated with multicast in a class data structure (CDS), such as a table. Each traffic class can represent a corresponding traffic pattern. The CDS can then also include a set of parameters (e.g., property values) representing each traffic class. Moreover, each of these traffic classes can be identified by a corresponding label. If a multicast flow matches a label, the MDPI system can classify the multicast flow with the class associated with the label.

To find the matching class for a multicast flow, the MDPI system can analyze a set of multicast packets of the multicast flow. For example, when an initial multicast packet is received at the switch, the forwarding hardware of the switch may not find a match. Hence, the forwarding hardware can promote the packet to a multicast daemon (e.g., a PIM daemon) that manages multicast traffic distribution at the switch. Promoting a packet can include providing the packet from the hardware of the switch to the software (e.g., the operating system) of the switch for further processing. When the packet is promoted, the MDPI system can capture a copy of the packet. The MDPI system can then determine the multicast address of the multicast group and the source address associated with the source of the multicast group from the packet. Here, the addresses can indicate the (source, group) or (S, G) combination representing the multicast flow associated with the packet. The MDPI system can create an entry in a flow data structure (FDS) for the multicast flow by applying a hash function to the (S, G) combination (e.g., to the source and multicast group addresses). The hash function can generate a hash value, which can then be an identifier of the multicast flow.

The MDPI system can also identify control packets, such as IGMP joins, associated with the multicast group and incorporate them in the set of multicast packets. In addition, the MDPI system can sample multicast packets (e.g., using IP Flow Information Export (IPFIX)) from the multicast flow and incorporate the sampled packets in the set of multicast packets. The MDPI system can then perform further analysis on the set of packets and can determine a set of properties for the multicast flow. The properties can include interface types, traffic direction, data rate, packet sizes, and application information. The interface types can include the ingress and egress interface types (e.g., access, multi-chassis link aggregation group (MC-LAG), etc.) for the multicast group at the switch. Similarly, the traffic direction can indicate whether the traffic is north-south traffic (e.g., from server to client) or east-west traffic (e.g., between end devices).

The MDPI system can then classify the multicast flow to determine a label for the multicast flow by applying a classifier or a clustering algorithm on the set of properties. The classification can include comparing the set of properties with the set of parameters in the CDS for a respective class. If the properties of a multicast flow match the parameters of a class, the MDPI system can determine the corresponding label from the entry in the CDS. The MDPI system can then allocate the label to the multicast flow and store the label in the entry associated with the multicast flow in the FDS. The MDPI system can then present the labels to a network management system (NMS), such as a network orchestrator.

By associating the multicast flows to corresponding labels, the MDPI system can efficiently perform DPI on the multicast flows in a network. Upon allocating a label to a multicast flow, the NMS can determine telemetry associated with the multicast flow and perform analysis based on the telemetry. Furthermore, the NMS can facilitate application-based policies in the network that can be defined based on respective combinations of user roles and applications. For example, the NMS can deploy a role-based access policy indicating which user role has a subscription to receive an IPTV stream. In addition, the determined telemetry can be used as inputs to different artificial intelligence (AI) based modeling. Based on the labels, an administrator (e.g., via a user interface of the NMS) may configure the network and allocate resources accordingly.

The network can be an overlay network, such as a distributed tunnel fabric, where the switches can be coupled to each other via tunnels. In the fabric, tunnel encapsulation is initiated and terminated within the fabric. The fabric can be coupled to other networks via a gateway device. The gateway device can be a virtual gateway switch (VGS). Typically, at least two switches can operate as a single switch in conjunction with each other to facilitate the VGS. If the network is an overlay network, the access switch can maintain an overlay CDS (OCDS) that can incorporate parameters associated with tunnels. For example, the interface type indicated in the OCDS can include a tunnel. Since the MDPI system can be deployed at the access switches, the MDPI system can determine the set of packets of a multicast flow for analysis and determine the corresponding label before or after the tunnel encapsulation is applied to the packets.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to the port that can receive or transmit data. “Port” can also refer to the hardware, software, and/or firmware logic that can facilitate the operations of that port.

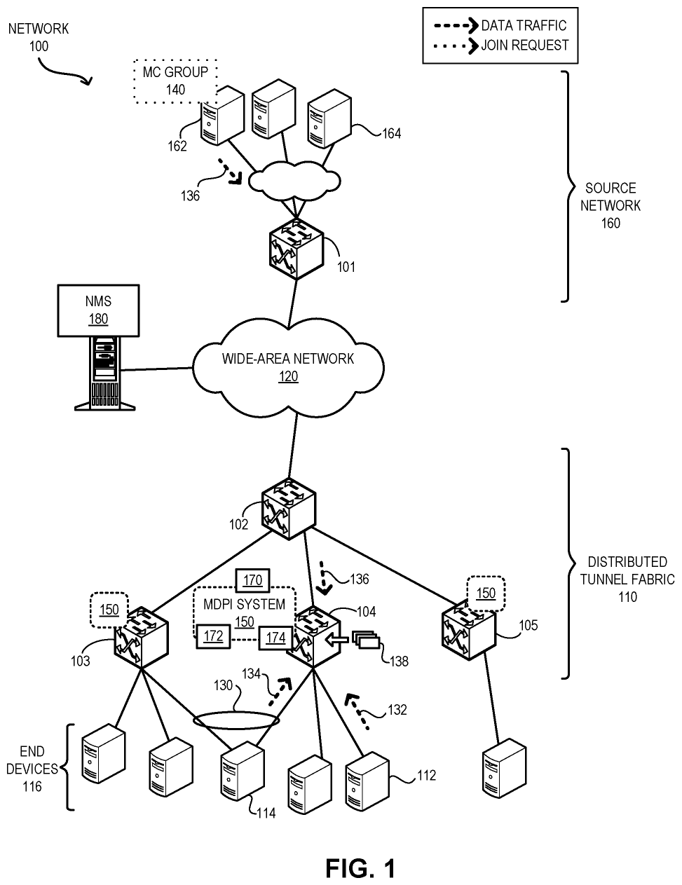

FIG. 1 illustrates an example of a network supporting deep-packet inspection of multicast flows, in accordance with an aspect of the present application. A network 100 can include a number of switches and devices, and may include heterogeneous network components, such as layer-2 and layer-3 hops, and tunnels. In some examples, network 100 can be an Ethernet network, InfiniBand network, or other network, and may use a corresponding communication protocol, such as Internet Protocol (IP), FibreChannel over Ethernet (FCOE), or other protocol. Network 100 can include a number of network devices, such as switches 102, 103, 104, and 105. Here, switches 103, 104, and 105 can be access switches, and switch 102 can be a border or gateway switch. Switches 103, 104, and 105 can be access switches because they can facilitate access to network 100 by connecting one or more end devices to network 100. A respective switch in network 100 can be associated with a MAC address and an IP address.

Switches 101, 102, 103, and 104 can be in a distributed tunnel fabric 110, where the switches can be coupled to each other via tunnels. In fabric 110, tunnel encapsulation is initiated and terminated within fabric 110. Switches in fabric 110 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). The tunnels in fabric 110 can be formed over an underlying network (or an underlay network). The underlying network can be a physical network, and a respective link of the underlying network can be a physical link. A respective switch pair in the underlying network can be a Border Gateway Protocol (BGP) peer. A VPN, such as an EVPN, can be deployed over fabric 110.

A number of end devices 116, such as end devices 112 and 114, can be coupled to the access switches via one or more hops. In other words, these end devices can be locally or remotely coupled to the access switches. For example, end device 114 can be coupled to switches 103 and 104 via an MC-LAG 130. Here, end device 114 can be coupled to switches 103 and 104 via respective links. These links can be grouped together to operate as a logical or virtual link, which is represented by MC-LAG 130. Furthermore, end device 112 can be coupled to switch 104 via a corresponding link. One or more of these end devices can be requesting hosts for a multicast group 140. For example, end devices 112 and 114 can send respective join requests 132 and 134 (e.g., IGMP or MLD joins) for multicast group 140. Hence, end devices 112 and 114 can also be referred to as hosts 112 and 114, respectively. Switch 104 can then send a corresponding network join request (e.g., a PIM join) to an RP of multicast group 140.

Switch 102 can facilitate external communication to switches 103, 104, and 105 via a wide-area network (WAN) 120 (e.g., an enterprise network or the Internet). Within network 100, network 120 can be coupled to a source network 160 (e.g., a data-center network or DCN that can facilitate a multicast flow) that can facilitate multicast flow for multicast group 140. Network 160 can include an end device 162, which can be the source of multicast group 140. Hence, end device 162 can also be referred to as source 162. Network 160 can include a switch 101, which can forward multicast steam 136 from end device 162 toward switch 102 via network 120. Switch 102 can then forward multicast flow 136 to end devices 112 and 114 via switch 104.

In some examples, performing a DPI on a packet may involve processing beyond the header of the packet. Based on the processing, the DPI process can identify a data flow from a request and its response (e.g., a Hypertext Transfer Protocol (HTTP) request and a corresponding response). The DPI can then determine the application and its corresponding traffic class (e.g., web traffic) from the data flow. However, even when a multicast packet in multicast flow 136 is processed beyond the multicast header of the packet, the application and its traffic class associated with a data flow may not be determined.

In particular, the multicast packet in multicast flow 136 can be distributed to all requesting hosts, such as end devices 112 and 114. Furthermore, another end device 164 may also operate as a source for multicast group 140. As a result, at least a portion of multicast flow 136 can also be sent from end device 164. Consequently, multicast flow 136 may not be associated with a particular source-destination pair. In addition, different types of applications may generate multicast traffic. As a result, identifying a multicast flow group may not be sufficient to determine the application and its associated traffic class.

Extracting information from multicast packets can be even more challenging when multicast flow 136 is sent via the tunnels in fabric 110. Because the packets of multicast flow 136 can be encapsulated with corresponding tunnel headers, the DPI process may not identify the multicast flow and its traffic class associated with multicast flow 136. Furthermore, information associated with multicast flow 136, such as port information, may not be universally defined. As a result, performing traditional DPI on multicast flow 136 may not determine the traffic class. Without performing DPI on multicast flows, telemetry associated with the multicast flows in network 100 may not be collected. Consequently, an administrator may not be able to allocate resources accordingly.

To address this problem, an MDPI system 150 capable of performing DPI on multicast flow 136 can be deployed on access switches 103, 104, and 105. MDPI system 150 can maintain a set of known traffic classes in a CDS 172. Each traffic class can represent a corresponding traffic pattern. Examples of a traffic class can include, but are not limited to, ultra-high definition (UHD) video streaming, high-definition (HD) video streaming (e.g., HD IPTV, video on demand (VOD), and online gaming), standard-definition (SD) video streaming (e.g., SD IPTV), closed-circuit television (CCTV), and low-definition (LD) CCTV or control traffic. CDS 172 can then also include a set of parameters (e.g., property values) representing each traffic class. Moreover, each of these classes can be identified by a corresponding label. If multicast flow 136 matches a label, MDPI system 150 can obtain the label from CDS 172 and classify multicast flow 136 with the class associated with the label.

CDS 172 can indicate that packet rates for video streaming can be medium to high. Multicast flows associated with video streaming can be north-south flows. For video streaming, join requests from requesting hosts are sent to access ports while the multicast streaming can be received from uplink switches (e.g., uplink LAGs). On the other hand, CDS 172 can indicate that packet rates for CCTV flows can be medium. CCTV flows can typically be south-north flows to an upstream server (e.g., from a datacenter). For example, a CCTV flow can arrive at switch 104 via an access port and forwarded to an uplink port. In addition, CDS 172 can indicate that control packets can be low-rate packets belonging to east-west flows between access switches.

MDPI system 150 running on switch 104 can analyze a set of packets for multicast group 140 to classify multicast flow 136. When MDPI system 150 receives the initial multicast packet of multicast flow 136, MDPI system 150 can determine the source address (e.g., the IP address of end device 162) and the multicast address of multicast group 140 from the multicast packet. Hence, the initial multicast packet of multicast flow 136 can be included in the set of packets. The source and multicast addresses indicate the (S, G) combination representing multicast flow 136. Hence, MDPI system 150 can identify multicast flow 136 based on the (S, G) combination. MDPI system 150 can then apply a hash function to the (source, group) combination to determine an entry in FDS 170 of switch 104 for multicast flow 136. The hash function may generate a flow identifier for multicast flow 136. The flow identifier can be used as the index of the entry in FDS 170. By performing this operation on each multicast flow forwarded through switch 104, MDPI system 150 can build a cache of multicast flows in FDS 170.

MDPI system 150 can also incorporate join requests 132 and 134 in the set of packets. In addition, MDPI system 150 can sample multicast packets based on a sampling rate from multicast flow 136. The sampling can select every nth packet of multicast flow 136 to obtain sampled multicast packets 138. MDPI system 150 may also use sampling mechanisms, such as IPFIX or NetFlow, to sample from multicast flow 136 to determine multicast packets 138. MDPI system 150 can then incorporate multicast packets 138 in the set of packets. In this way, MDPI system 150 can select the packets of multicast flow 136 to perform the DPI on.

Accordingly, MDPI system 150 can perform further analysis on the set of packets and can determine a set of properties for multicast flow 136. Examples of the properties can include, but are not limited to, interface types, traffic direction, data rate, packet sizes, and application information. For instance, MDPI system 150 can determine, based on the interfaces of join requests 132 and 134, that switch 104 can forward multicast flow 136 via an access port to end device 112 and via an MC-LAG 130 to end device 114. MDPI system 150 can then compare the set of properties with the set of parameters of each traffic class in CDS 172 using a classifier or a clustering algorithm. If the set of properties corresponds to the set of parameters of a traffic class, the MDPI system 150 can allocate the corresponding label to multicast flow 136. The MDPI system 150 can include the label in the corresponding entry in FDS 170.

By associating multicast flow 136 to a corresponding label, MDPI system 150 can efficiently perform DPI on multicast flow 136. MDPI system 150 can then present the label to an NMS 180. An administrator can configure and provision a respective network device in network 100 using NMS 180. Upon allocating a label to a multicast flow, NMS 180 can determine telemetry associated with the multicast flow and perform analysis based on the telemetry. The determined telemetry can be used as inputs to different AI-based modeling. NMS 180 can also facilitate application-based policies in the network that can be defined based on respective combinations of user roles and applications. Furthermore, based on the label, an administrator (e.g., via a user interface of NMS 180) may configure network 100 and allocate resources accordingly. For example, if multicast flow 136 corresponds to a video stream, a policy defined in network 100 can indicate whether end devices 112 and 114 have the subscription to receive the video stream. The administrator can also configure switches 102 and 104 to reduce the latency of multicast flow 136 and ensure a better viewing experience at end devices 112 and 114.

In fabric 110, switch 104 can also maintain a OCDS 174 that can incorporate parameters associated with tunnels. For example, the interface type indicated in OCDS 174 can include a tunnel. Since MDPI system 150 can be deployed at access switches 103, 104, and 105, MDPI system 150 can determine the set of packets of multicast flow 136 for analysis and determine the corresponding label before or after the tunnel encapsulation is applied to the packets. For example, upon receiving join requests 132 and 134, switch 104 can perform the analysis on them before encapsulating join requests 132 and 134 with corresponding tunnel headers. On the other hand, switch 104 can decapsulate the respective tunnel headers of the packets of multicast flow 136. MDPI system 150 can perform the sampling on the decapsulated packets of multicast flow 136 and select multicast packets 138. Therefore, MDPI system 150 can be deployed in a fabric to perform the DPI on multicast packets.

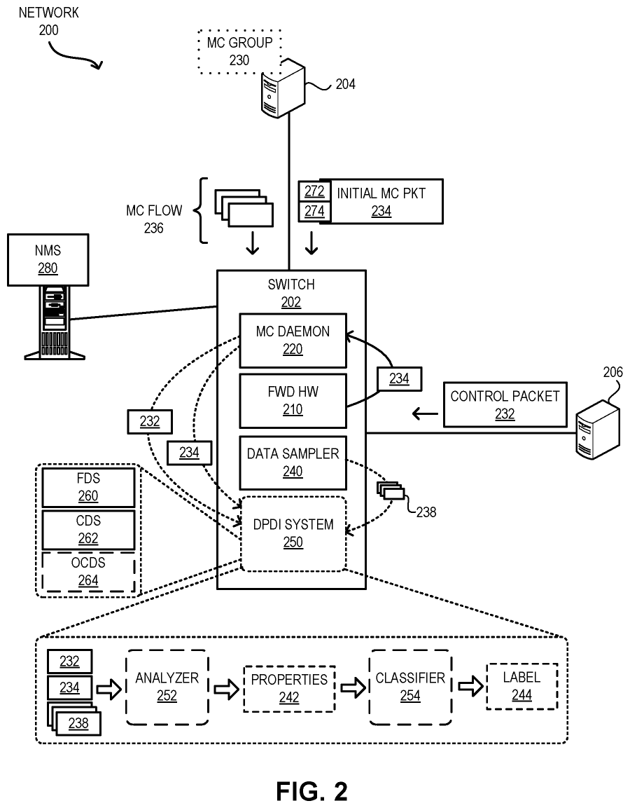

FIG. 2 illustrates an example of an MDPI system gleaning information from a multicast flow, in accordance with an aspect of the present application. A switch 202, which can be an access switch in a network 200, can deploy an MDPI system 250. An end device 206 can be coupled to switch 202 via an access port of switch 202. End device 206 can be interested in receiving multicast traffic of a multicast group 230. Accordingly, end device 206 can send a join request (e.g., an IGMP or MLD join) of multicast group 230 to switch 202. In turn, switch 202 can send a network join request (e.g., a PIM join) of multicast group 230 to an RP of multicast group 230. An end device 204 can be a source of multicast group 230 in network 200. When end device 204 becomes aware of the network join from switch 202, end device 204 can send a multicast flow 236 comprising multicast packets (i.e., data packets) of multicast group 230 to switch 202.

During operation, switch 202 can receive an initial multicast packet 234 of multicast flow 236. When switch 202 receives packet 234, forwarding hardware 210 of switch 202 may not find a match in a forwarding data structure (e.g., in the content-addressable memory or CAM). Hence, forwarding hardware 210 can promote packet 234 to a multicast daemon 220 (e.g., a PIM daemon) that manages multicast traffic distribution at switch 202. Promoting packet 234 can include providing it from forwarding hardware 210 to the software (e.g., the operating system running multicast daemon 220) of switch 202 for further processing. When packet 234 is promoted, MDPI system 250 can capture a copy of packet 234. An analyzer 252 can then determine multicast address 274 of multicast group 230 and source address 272 associated with source 204 from packet 234. Here, addresses 272 and 274 can indicate the (S, G) combination representing multicast flow 236 of multicast group 230. MDPI system 250 can create an entry in FDS 260 for multicast flow 236 by applying a hash function to the (S, G) combination (e.g., to addresses 272 and 274).

MDPI system 250 can also identify control packets, such control packet 232, associated with multicast group 230. End device 206 can send control packet 232 to switch 202. Control packet 232 can be an IGMP or MLD join requesting traffic from multicast group 230. When multicast daemon 220 processes control packet 232, MDPI system 250 can capture a copy of packet 232. Analyzer 252 can perform further analysis on packet 232 and identify the port coupling end device 206 (i.e., a requesting host). Analyzer 252 can also determine the replication volume and direction for multicast flow 236.

In addition, MDPI system 250 can sample multicast packets (e.g., using a data sampler 240, such as IPFIX) from multicast flow 236 and analyze sampled packets 238. Analyzer 252 can determine the packet and byte counter values from sampled packets 238. In this way, MDPI system 250 can perform further analysis on packets 232, 234, and 238 and can determine a set of properties 242 for multicast flow 236. Properties 242 can include interface types, traffic direction, data rate, packet sizes, and application information. The interface types can include the ingress and egress interface types (e.g., access, MC-LAG, etc.) for multicast group 230 at switch 202. Similarly, the traffic direction can indicate whether the traffic of multicast flow 236 is north-south traffic or east-west traffic.

MDPI system 250 can then classify multicast flow 236 to determine a label 244 for multicast flow 236. To do so, MDPI system 250 can apply a classifier 254 on properties 242. The classification can include comparing properties 242 with the set of parameters in CDS 262 for a respective traffic class. If properties 242 matches the parameters of a class in FDS 260, MDPI system 250 can determine label 244 from the corresponding entry in CDS 262. MDPI system 250 can then allocate label 244 to multicast flow 236 and store label 244 in the entry associated with multicast flow 236 in FDS 260. MDPI system 250 can then present label 244 to NMS 280. If network 200 is an overlay network, switch 202 can maintain an OCDS 264 that can incorporate parameters associated with tunnels. Since switch 202 can be an access switch, MDPI system 250 can determine label 244 before the tunnel encapsulation is applied to the packets. By associating multicast flow 236 to a corresponding label 244, the MDPI system can efficiently perform DPI on the multicast flows in a network.

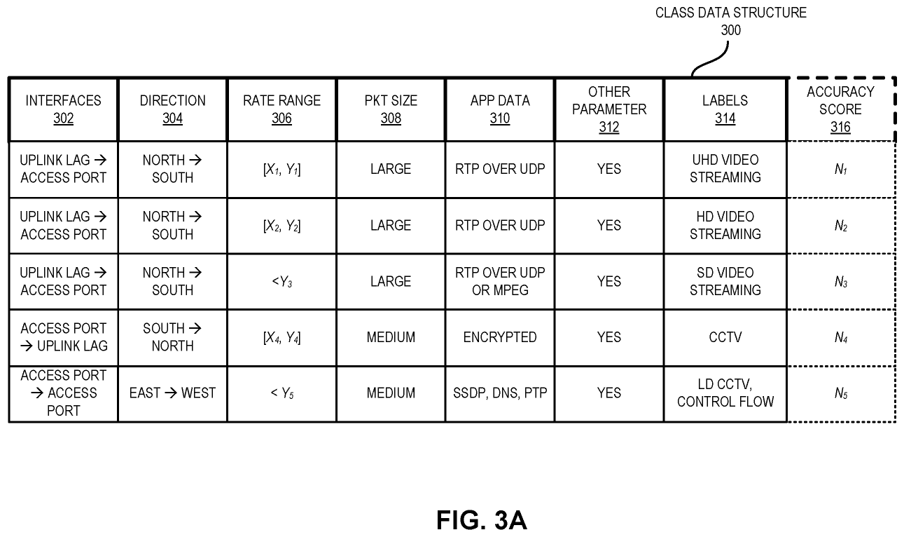

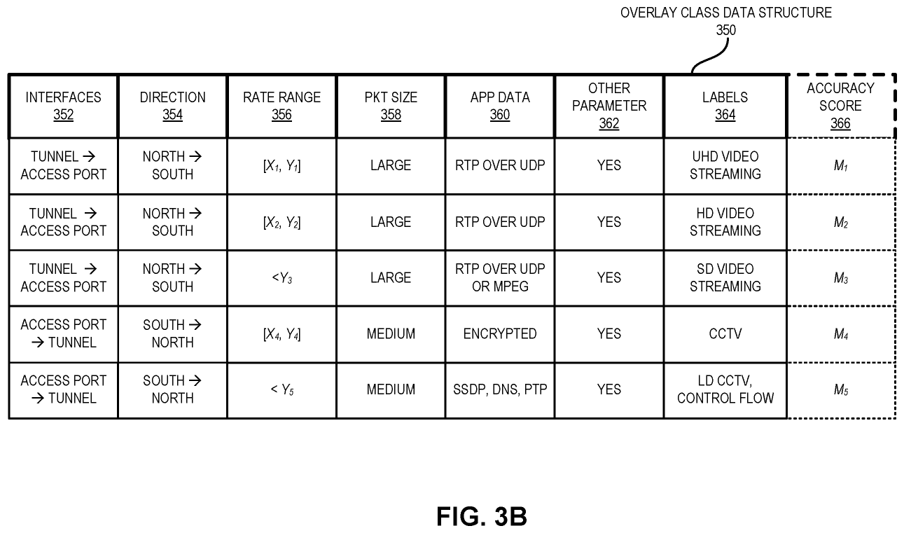

FIG. 3A illustrates an example of a class data structure based on which an MDPI system classifies a multicast flow, in accordance with an aspect of the present application. A CDS 300 can include a set of parameters for a number of predetermined traffic classes. To represent the parameters, CDS 300 can include interfaces 302, a direction of traffic 304, a rate range 306, a packet size 308, application data 310, presence of other parameters 312, labels 314, and accuracy score 316. Accuracy score 316 can be an optional field (denoted with dashed lines). If a multicast flow is a north-south flow from an uplink LAG to an access port, other parameters (e.g., IGMP joins) are present, the packet size is large, and the application data is carried by Real Time Transport Protocol (RTP) over User Datagram Protocol (UDP), CDS 300 can include a label of video streaming. In other words, such a multicast flow can be classified as video streaming.

If the data rate of the video streaming is within a range of [X₁, Y₁] (e.g., 50 Mbps-300 Mbps), the label of the corresponding entry can be UHD video streaming. On the other hand, if the data rate is within a range of [X₂, Y₂] (e.g., 30 Mbps-50 Mbps), the label can be HD video streaming. Similarly, if the data rate is less than Y₃ (e.g., <10 Mbps), the label can be SD video streaming. The application data for SD video streaming can also indicate Moving Picture Experts Group (MPEG) streaming. Furthermore, if a multicast flow is a south-north flow from an access port to an uplink LAG, other parameters are present, the packet size is medium, has a data rate in a range of [X₄, YA] (e.g., 5 Mbps-10 Mbps), CDS 300 can include a label of CCTV. Because such a multicast flow can be encrypted, application data may not be available.

In addition, if a multicast flow is an east-west flow between access ports, other parameters are present, the packet size is medium, has a low data rate (e.g., <Y₅), CDS 300 can include a label of low-definition (LD) CCTV or control flow. For example, if the application data indicates Simple Service Discovery Protocol (SSDP), Domain Name System (DNS), or Precision Time Protocol (PTP), the label can be a control flow. Otherwise, the label can be LD CCTV. If the properties of a multicast flow match the parameters of an entry of CDS 300, the corresponding label is allocated to the multicast flow. Accuracy score 316 can indicate how well a multicast flow is matched with a corresponding traffic class. Accuracy score 316 can be UHD video streaming, HD video streaming, SD video streaming, CCTV, and LD CCTV or control flow can be N₁, N₂, N₃, N₄, and N₅, respectively. These scores can improve with more classifications.

FIG. 3B illustrates an example of an overlay class data structure based on which an MDPI system classifies a multicast flow in an overlay network, in accordance with an aspect of the present application. An OCDS 350 can include a set of parameters for a number of predetermined traffic classes in an overlay network. To represent the parameters, CDS 350 can include interfaces 352, a direction of traffic 354, a rate range 356, a packet size 358, application data 360, presence of other parameters 362, labels 364, and accuracy score 366. Accuracy score 366 can be an optional field (denoted with dashed lines). If a multicast flow is a north-south flow from a tunnel to an access port, other parameters are present, the packet size is large, and the application data is carried by RTP over UDP, CDS 350 can include a label of video streaming.

If the data rate of the video streaming is within a range of [X₁, Y₁], the label of the corresponding entry can be UHD video streaming. On the other hand, if the data rate is within a range of [X₂, Y₂], the label can be HD video streaming. Similarly, if the data rate is less than Y₃, the label can be SD video streaming. The application data for SD video streaming can also indicate MPEG streaming. Furthermore, if a multicast flow is a south-north flow from an access port to a tunnel, other parameters are present, the packet size is medium, has a data rate in a range of [X₄, Y₄], CDS 350 can include a label of CCTV. Because such a multicast flow can be encrypted, application data may not be available.

In addition, if a multicast flow is a south-north flow from an access port to a tunnel, other parameters are present, the packet size is medium, has a low data rate (e.g., <Y₅), CDS 350 can include a label of LD CCTV or control flow. For example, if the application data indicates SSDP, DNS, or PTP, the label can be a control flow. Otherwise, the label can be LD CCTV. If the properties of a multicast flow match the parameters of an entry of CDS 350, the corresponding label is allocated to the multicast flow. Accuracy score 366 can indicate how well a multicast flow is matched with a corresponding traffic class. Accuracy score 366 can be UHD video streaming, HD video streaming, SD video streaming, CCTV, and LD CCTV or control flow can be M₁, M₂, M₃, M₄, and M₅, respectively. These scores can improve with more classifications.

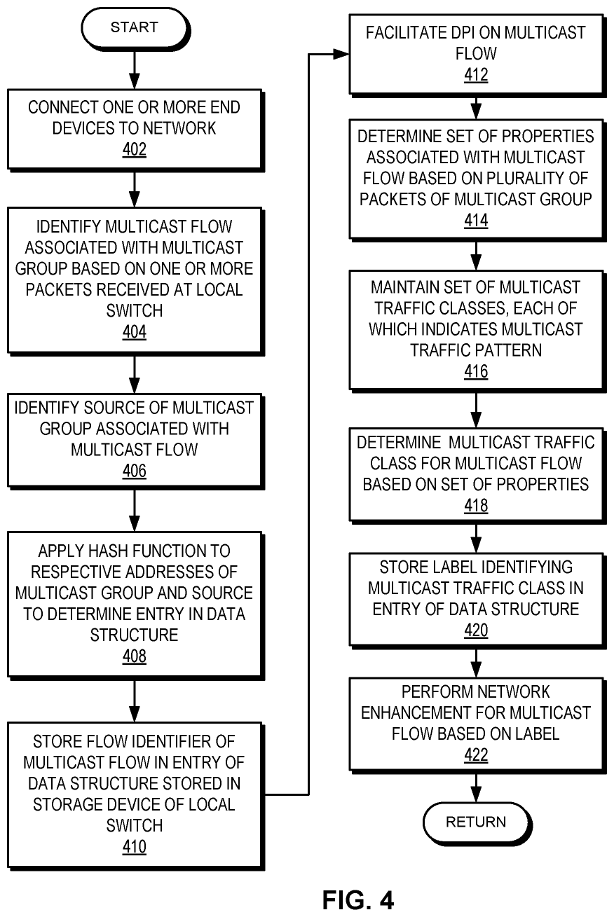

FIG. 4 presents a flowchart illustrating an example of a process of a switch performing a deep-packet inspection on a multicast flow in a network, in accordance with an aspect of the present application. During operation, the switch can connect one or more end devices in the network (operation 402). Since the switch connects to end devices, the switch can be an access switch. The switch can then deploy an MDPI system and perform DPI on multicast flows in the network. To do so, the switch can identify a multicast flow associated with a multicast group based on one or more packets received at the local switch (operation 404). The one or more packets can include the initial multicast packet (i.e., the initial data packet) of the multicast flow received at the switch.

The switch can then identify a source of the multicast group associated with the multicast flow (operation 406). The switch can then apply a hash function to the respective addresses of the multicast group and the source to determine an entry in the data structure (e.g., an FDS) (operation 408). Here, the hash function can generate a hash value. The switch can then identify the entry (i.e., the location in the data structure) based on the hash value. Subsequently, the switch can store a flow identifier of the multicast flow in the entry of the data structure stored in a storage device of the switch (operation 410). The hash value generated by the hash function can be the flow identifier.

The switch can then facilitate the DPI on the multicast flow (operation 412). To facilitate the DPI, the switch can determine a set of properties associated with the multicast flow based on a plurality of packets of the multicast group (operation 414). The plurality of packets can include an initial packet of the multicast flow, control packets, such as join requests, of the multicast group, and packets sampled from the multicast flow. The switch can also maintain a set of multicast traffic classes, each of which indicates a multicast traffic pattern (e.g., in a CDS or an OCDS) (operation 416). These traffic classes can be predefined based on typical applications, such as IPTV, CCTV, online gaming, and control traffic. The traffic pattern of a respective traffic class can be represented by a set of parameters. For example, if the parameters indicate a north-south flow with a high data rate and large packet sizes, and the application data is carried by RTP over UDP, the corresponding traffic class can be UHD or HD video streaming.

The switch can determine a multicast traffic class for the multicast flow based on the set of properties (operation 418). The switch can compare the set of properties with the set of parameters of a respective traffic class and determine the traffic class based on a match. The matched traffic class can be associated with a label. The switch can then store the label identifying the multicast traffic class in the entry of the data structure (operation 420). The switch can then perform network enhancement for the multicast flow based on the label (operation 422). Examples of the network enhancement can include, but are not limited to, enforcing a role-based access policy indicating which user role has permission to receive the multicast flow and applying a set of configurations associated with the traffic class at the local switch.

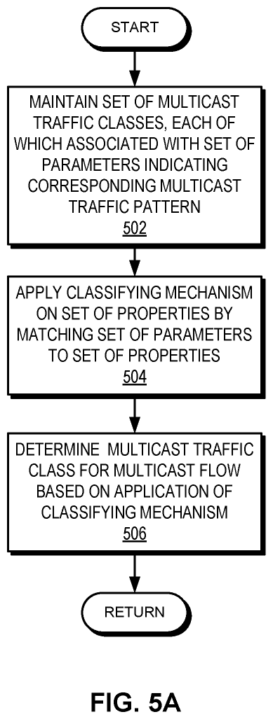

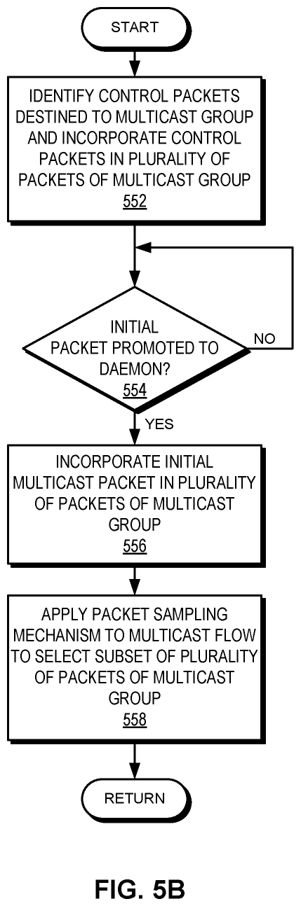

FIG. 5A presents a flowchart illustrating an example of a process of a switch classifying a multicast flow in a network, in accordance with an aspect of the present application. During operation, the switch can maintain a set of multicast traffic classes, each of which can be associated with a set of parameters indicating a corresponding multicast traffic pattern (operation 502). The switch can apply a classifying mechanism on the set of properties by matching the set of parameters to the set of properties (operation 504). The matching can include comparing the set of properties with a respective set of parameters of individual traffic classes. The switch can then determine a multicast traffic class for the multicast flow based on the application of the classifying mechanism (operation 506). In other words, the classifying mechanism can classify the multicast flow to the multicast traffic class whose parameters match the properties of the multicast flow.

FIG. 5B presents a flowchart illustrating an example of a process of a switch selecting multicast packets to perform a deep-packet inspection, in accordance with an aspect of the present application. During operation, the switch can identify control packets destined to the multicast group and incorporate the control packets in the plurality of multicast packets of the multicast group (operation 552). Here, the switch can perform the DPI based on the plurality of multicast packets. The switch can also determine whether an initial multicast packet of the multicast flow is promoted to the multicast daemon of the switch (operation 554). Since the forwarding hardware of the switch may not find a match for the initial multicast packet, the forwarding hardware may promote the initial multicast packet to the multicast daemon. Promoting a packet can include providing the packet from the hardware of the switch to the software (e.g., the operating system) of the switch for further processing.

Until the initial multicast packet is promoted to the multicast daemon, the switch can continue to check for the initial multicast packet of the multicast flow to be promoted to the multicast daemon of the switch (operation 554). On the other hand, if the initial multicast packet is promoted to the multicast daemon, the switch can incorporate the initial multicast packet in the plurality of packets of the multicast group (operation 556). The switch can identify the multicast flow based on the initial multicast packet. Furthermore, the initial multicast packet can trigger the DPI process on the multicast flow. Accordingly, the switch can apply a packet sampling mechanism (e.g., IPFIX) to the multicast flow to select a subset of the plurality of packets of the multicast group (operation 558).

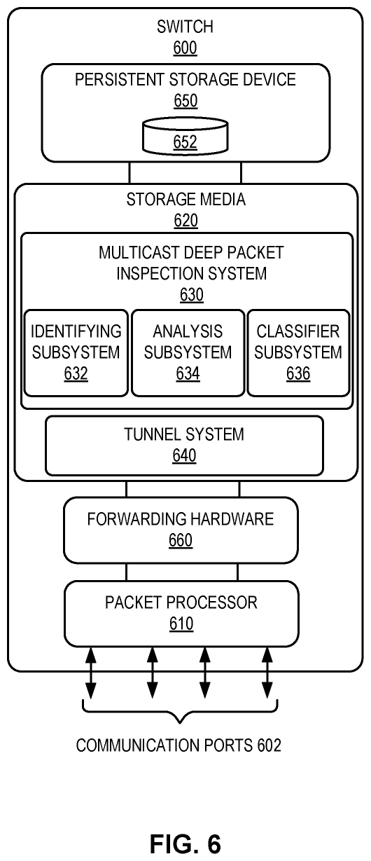

FIG. 6 illustrates an example of a switch supporting deep-packet inspection of multicast flows, in accordance with an aspect of the present application. In this example, a switch 600, which can also be referred to as a switch 600, can include a number of communication ports 602, a packet processor 610, and a persistent storage device 650. Switch 600 can also include forwarding hardware 660 (e.g., processing hardware of switch 600, such as its application-specific integrated circuit (ASIC) chips), which includes information based on which switch 600 processes packets (e.g., determines output ports for packets). Packet processor 610 can extract and process header information from the received packets. Packet processor 610 can identify a network device identifier (e.g., a MAC address and/or an IP address) associated with switch 600 in the header of a packet. Switch 600 can include a storage media 620. In some examples, storage media 620 can include a set of volatile memory devices (e.g., dual in-line memory module (DIMM)).

Communication ports 602 can include inter-device communication channels for communication with other network devices and/or user devices. The communication channels can be implemented via a regular communication port and based on any open or proprietary format. Communication ports 602 can include one or more Ethernet ports capable of receiving frames encapsulated in an Ethernet header. Communication ports 602 can also include one or more IP ports capable of receiving IP packets. An IP port is capable of receiving an IP packet and can be configured with an IP address. Packet processor 610 can process Ethernet frames and/or IP packets. A respective port of communication ports 602 may operate as an ingress port and/or an egress port.

Switch 600 can maintain a database 652 (e.g., in storage device 650). Database 652 can be a relational database and may run on one or more Database Management System (DBMS) instances. Database 652 can store information associated with the routing, configuration, and interfaces of switch 600. Database 652 may store the FDS, CDS, and OCDS for switch 600. Storage Media 620 can include instructions associated with a tunnel system 640. Tunnel system 640 can allow switch 600 to operate as a tunnel endpoint in a tunnel fabric. To do so, tunnel system 640 may establish a tunnel with one or more remote switches. Storage Media 620 can include instructions associated with an MDPI system 630 that can allow switch 600 to efficiently forward bidirectional multicast traffic.

MDPI system 630 can include an identifying subsystem 632, an analysis subsystem 634, and a classifier subsystem 636. Identifying subsystem 632 can identify a multicast flow associated with a multicast group based on one or more packets received at switch 600. The one or more packets can include the initial multicast packet (i.e., the initial data packet) of the multicast flow received at switch 600. Identifying subsystem 632 can also identify a source of the multicast group associated with the multicast flow and apply a hash function to the respective addresses of the multicast group and the source to determine an entry in an FDS.

Analysis subsystem 634 can determine a set of properties associated with the multicast flow based on a plurality of packets of the multicast group. The plurality of packets can include an initial packet of the multicast flow, control packets, such as join requests, of the multicast group, and packets sampled from the multicast flow. Subsequently, classifier subsystem 636 can determine a multicast traffic class for the multicast flow based on the set of properties. Classifier subsystem 636 can compare the set of properties with the set of parameters of a respective traffic class and determine the traffic class based on a match. The matched traffic class can be associated with a label. Classifier subsystem 636 can then store the label identifying the multicast traffic class in the entry of the FDS.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide an access switch, which can connect one or more end devices to a network. During operation, the access switch can identify a multicast flow associated with a multicast group based on one or more packets received at the access switch. The access switch can store a flow identifier of the multicast flow in an entry of a data structure stored in a storage device of the access switch. Subsequently, the access switch can facilitate deep-packet inspection on the multicast flow. To do so, the access switch can determine a set of properties associated with the multicast flow based on a plurality of packets of the multicast group and determine a multicast traffic class for the multicast flow based on the set of properties. The access switch can then store a label identifying the multicast traffic class in the entry of the data structure.

In a variation on this aspect, the multicast flow can be further associated with a source of the multicast group. The access switch can then apply a hash function to respective addresses of the multicast group and the source to determine the entry in the data structure.

In a variation on this aspect, the access switch can maintain a set of multicast traffic classes. Here, each multicast class indicates a multicast traffic pattern. The access switch can then apply a classifying mechanism on the set of properties to determine the multicast traffic class for the multicast flow.

In a further variation, each multicast traffic class can correspond to a set of parameters indicating a corresponding traffic pattern. The access switch can then apply the classifying mechanism by matching the set of parameters to the set of properties.

In a variation on this aspect, the set of properties of the multicast flow include one or more of: interface types, traffic direction, data rate, packet sizes, and application information associated with the multicast flow, and wherein the interface types include: a routed interface, a link-aggregation group (LAG), and a tunnel interface.

In a variation on this aspect, the access switch can apply a packet sampling mechanism to the multicast flow to select a subset of the plurality of packets of the multicast group.

In a variation on this aspect, the network can be an overlay network. The plurality of packets of the multicast group can then be received from or destined to a tunnel of the overlay network.

In a variation on this aspect, the one or more packets include control and data packets associated with the multicast group.

In a variation on this aspect, the access switch can perform one or more network enhancements based on the label. The network enhancements can include enforcing a role-based access policy indicating which user role has permission to receive the multicast flow. The network enhancements can also include applying a set of configurations associated with the multicast traffic class at the access switch.

In a variation on this aspect, the access switch can identify the multicast flow associated with the multicast group by receiving an initial multicast packet of the multicast flow and determining that the initial multicast packet is provided to a multicast daemon of the access switch from forwarding hardware of the switch. The access switch can then determine addresses associated with the multicast flow from the initial multicast packet.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method comprising:
identifying, by an access switch in a network, a multicast flow associated with a multicast group based on one or more packets received at the access switch, wherein a respective access switch connects one or more end devices to the network;
storing a flow identifier of the multicast flow in an entry of a data structure stored in a storage device of the access switch;
facilitating deep-packet inspection on the multicast flow by:
determining a set of properties associated with the multicast flow based on a plurality of packets of the multicast group; and
determining a multicast traffic class for the multicast flow based on the set of properties; and
storing a label identifying the multicast traffic class in the entry of the data structure.

2. The method of claim 1, wherein the multicast flow is further associated with a source of the multicast group; and
wherein the method further comprises applying, by the access switch, a hash function to respective addresses of the multicast group and the source to determine the entry in the data structure.

3. The method of claim 1, further comprising:
maintaining, by the access switch, a set of multicast traffic classes, wherein each multicast class indicates a multicast traffic pattern; and
applying, by the access switch, a classifying mechanism on the set of properties to determine the multicast traffic class for the multicast flow.

4. The method of claim 3, wherein each multicast traffic class corresponds to a set of parameters indicating a corresponding traffic pattern; and
wherein applying the classifying mechanism further comprises matching the set of parameters to the set of properties.

5. The method of claim 1, wherein the set of properties of the multicast flow include one or more of: interface types, traffic direction, data rate, packet sizes, and application information associated with the multicast flow, and wherein the interface types include: a routed interface, a link-aggregation group (LAG), and a tunnel interface.

6. The method of claim 1, further comprising applying, by the access switch, a packet sampling mechanism to the multicast flow to select a subset of the plurality of packets of the multicast group.

7. The method of claim 1, wherein the network is an overlay network, and wherein the plurality of packets of the multicast group are received from or destined to a tunnel of the overlay network.

8. The method of claim 1, wherein the one or more packets include control and data packets associated with the multicast group.

9. The method of claim 1, further comprising performing a network enhancement based on the label by one or more of:
enforcing a role-based access policy indicating which user role has permission to receive the multicast flow; and
applying a set of configurations associated with the multicast traffic class at the access switch.

10. The method of claim 1, wherein identifying the multicast flow associated with the multicast group further comprises:
receiving an initial multicast packet of the multicast flow;
determining that the initial multicast packet is provided to a multicast daemon of the access switch from forwarding hardware of the switch; and
determining addresses associated with the multicast flow from the initial multicast packet.

11. A non-transitory computer-readable storage medium storing instructions that when executed by a processor of access switch in a network cause the processor to perform a method, the method comprising:
identifying a multicast flow associated with a multicast group based on one or more packets received at the access switch, wherein a respective access switch connects one or more end devices to the network;
storing a flow identifier of the multicast flow in an entry of a data structure stored in a storage device of the access switch;
facilitating deep-packet inspection on the multicast flow by:
determining a set of properties associated with the multicast flow based on a plurality of packets of the multicast group; and
determining a multicast traffic class for the multicast flow based on the set of properties; and
storing a label identifying the multicast traffic class in the entry of the data structure.

12. The non-transitory computer-readable storage medium of claim 11, wherein the multicast flow is further associated with a source of the multicast group;
wherein the method further comprises applying a hash function to respective addresses of the multicast group and the source to determine the entry in the data structure.

13. The non-transitory computer-readable storage medium of claim 11, wherein the method further comprises:
maintaining, by the access switch, a set of multicast traffic classes, wherein each multicast class indicates a multicast traffic pattern; and
applying, by the access switch, a classifying mechanism on the set of properties to determine the multicast traffic class for the multicast flow.

14. The non-transitory computer-readable storage medium of claim 13, wherein each multicast traffic class corresponds to a set of parameters indicating a corresponding traffic pattern; and
wherein applying the classifying mechanism further comprises matching the set of parameters to the set of properties.

15. The non-transitory computer-readable storage medium of claim 11, wherein the set of properties of the multicast flow include one or more of: interface types, traffic direction, data rate, packet sizes, and application information associated with the multicast flow, and wherein the interface types include: a routed interface, a link-aggregation group (LAG), and a tunnel interface.

16. The non-transitory computer-readable storage medium of claim 11, wherein the method further comprises applying a packet sampling mechanism to the multicast flow to select a subset of the plurality of packets of the multicast group.

17. The non-transitory computer-readable storage medium of claim 11, wherein the network is an overlay network, and wherein the plurality of packets of the multicast group are received from or destined to a tunnel of the overlay network.

18. The non-transitory computer-readable storage medium of claim 11, further comprising performing a network enhancement based on the label by one or more of: 2
enforcing a role-based access policy indicating which user role has permission to receive the multicast flow; and
applying a set of configurations associated with the multicast traffic class at the access switch.

19. The non-transitory computer-readable storage medium of claim 11, wherein identifying the multicast flow associated with the multicast group further comprises:
receiving an initial multicast packet of the multicast flow;
determining that the initial multicast packet is provided to a multicast daemon of the access switch from forwarding hardware of the switch; and
determining addresses associated with the multicast flow from the initial multicast packet.

20. A computer system, comprising:
a processing resource;
a storage device; and
a non-transitory machine-readable medium comprising instructions executable by the processing resource to:
connect one or more end devices to a network;
identify a multicast flow associated with a multicast group based on one or more packets received at the computer system;
store a flow identifier of the multicast flow in an entry of a data structure stored in the storage device;
facilitate deep-packet inspection on the multicast flow by:
determining a set of properties associated with the multicast flow based on a plurality of packets of the multicast group; and
determining a multicast traffic class for the multicast flow based on the set of properties; and
store a label identifying the multicast traffic class in the entry of the data structure.
